(19) United States
(12) Patent Application Publication
(10) Pub. No.: US 2025/0230835 A1
(43) Pub. Date: Jul. 17, 2025

(54) LIMITING DEVICE AND METHOD FOR LIMITING THE MOBILITY OF A ROTARY JOINT

(71) Applicant: KARL STORZ SE & Co. KG, Tuttlingen (DE)

(72) Inventor: Sven GRÜNER, Tuttlingen (DE)

(21) Appl. No.: 18/849,023

(22) PCT Filed: Mar. 22, 2023
(86) PCT No.: PCT/EP2023/057389

§ 371 Date: Sep. 20, 2024

(30) Foreign Application Priority Data
Mar. 23, 2022 (DE) 10 2022 106 843.9

(51) Int. Cl. F16C 11/06

(52) U.S. Cl. CPC F16C 11/0623

(57) ABSTRACT

A device, system and method limit the mobility of a rotary joint, preferably for a holding device for applications in human or veterinary medicine. The device includes two joint parts, rotatable and pivotable relative to each other about three axes, and at least one first roller body for limiting the relative mobility of the joint parts. Both joint parts have in each case at least one first recess for guiding the at least one first roller body between the joint parts and the respective stops of the recesses in order to move the joint parts relative to each other in an angle range limited by the stops.

### CROSS REFERENCE TO RELATED APPLICATIONS

This application is a United States National Phase Application of International Application PCT/EP2023/057389, filed Mar. 22, 2023, and claims the benefit of priority under 35 U.S.C. § 119 of German Application 10 2022 106 843.9, filed Mar. 23, 2022, the entire contents of which are incorporated herein by reference.

### TECHNICAL BACKGROUND

The invention relates to a device for limiting the mobility of a rotary joint, in particular a ball joint, and a system comprising at least one holding device with a rotary joint with a limiting device and a supply line along the joint parts of the rotary joint. Furthermore, the invention relates to a method for limiting the mobility of a rotary joint.

Rotary joints, in particular ball joints, are used in a variety of applications. Such rotary joints are often used, among other things, in holding devices or holding arms in medical technology, which are of great use for instrument guidance during minimally invasive surgical procedures due to the degrees of freedom having little limitation. By means of an articulated design, e.g., at the distal end of a holding device, a surgeon, assistant, or other operating personnel can hold and precisely position an instrument such as a manipulator, an optical aid such as an endoscope, a clamp, or the like. It is known that the set position of the holding device can be fixed by locking the joint. Furthermore, in medical technology, manually controllable, semi-automated, or fully automated holding devices can be used to support telemedicine (telesurgery) or surgical treatments.

The holding devices can be combined with endoscopes as well as with microscopes or colposcopes. Furthermore, a holding device in conjunction with camera systems and/or manipulators can also be used outside of medical technology to examine difficult-to-access technical cavities. Instruments or manipulators with motor and, if necessary, even robotic control can be connected to a holding device in order to control movements and functions of the distally connected instrument.

For the operation of articulated holding devices for medical instruments, cleaning devices, or the like, it is usually necessary to run at least one supply line along the articulated parts of the holding device. With the help of one or more supply lines, instruments or tools that are carried, moved, and/or controlled by the holding device can be supplied with energy, light, and/or fluids such as gas or water. Fluids can, for example, be sterile isotonic saline solutions that can be used to clean an endoscope window and/or lighting devices, or as hydraulic fluid. A “supply line” in the sense of the invention can also be used to suction off fluids. Supply lines can also be used to electrically, pneumatically, or hydraulically move and control instruments located distally on the holding device. In the following, the term “supply line” refers to lines that can transmit or convey energy, fluids, control signals, or data in both directions (distal and proximal).

However, if one or more supply lines are routed over a rotary joint, the problem is that unlimited rotation of the rotary joint, in particular a ball joint, around the outgoing axis of the ball is disadvantageous. In particular, due to the endless rotation of a rotary joint, one or more supply lines can become wound around at least one joint part and may be damaged if the load is too high. Tensile loads and/or torsional loads caused by twisting threaten to damage the lines or to reduce the line cross-section, and there is a risk that damage cannot be detected visually if the damage is inside the cable.

In particular, it is important to note that supply lines in the form of electrical cables and pressure lines must be subjected only to limited and controlled mechanical stress, as these types of lines are subject to strict regulations and safety rules. Leaks caused by excessive stress on supply lines containing liquids should also be avoided, since hydraulically operated end effectors, for example, cannot be controlled or can no longer be controlled reliably if there is a leak caused by excessive stress.

### SUMMARY

It is an object of the invention to create a device for limiting a rotary joint so that the rotary joint can be moved only within a limited angle of rotation range. The device should not completely prevent the rotation of the joint, since a certain rotation, e.g., around the rotation axis of the rotary joint, is necessary for the handling of the positioning device to be as simple, comfortable, and ergonomic as possible.

For a system with an articulated holding device and a supply line running over the joint, it is in addition the object of the invention to provide a rotary joint with a limited angle of rotation range in order to avoid high loads on the supply line due to tension, pressure, twisting, torsion, or distortion. At the same time, despite a limitation of the rotation, sufficient stability of the rotary joint must be ensured during normal operation and when the rotary joint is locked.

### DESCRIPTION OF THE INVENTION

Based upon the invention, the above-mentioned objects are to be achieved better than with conventional mechanical rotary joints such as ball joints. These objects are achieved by a device, system, and method according to the invention for limiting the mobility of a rotary joint, according to the features of the independent claims. Preferred embodiments of the invention are disclosed in the claims, description and figures.

According to a first aspect of the invention, a device for limiting the mobility of a rotary joint is provided, preferably for a holding device for human or veterinary medical applications, wherein the device comprises two joint parts which can be rotated and pivoted relative to one another about three axes. The device further comprises at least one first roller body for limiting the relative mobility of the joint parts; wherein both joint parts each have at least one first recess for guiding the at least one first roller body between the joint parts and the corresponding stops of the recesses in order to move the joint parts relative to one another in an angle range limited by the stops.

The limitation of the angle range can be used advantageously if at least one supply line is fixed on the one hand to the first joint part and on the other to the second joint part by means of fixing devices. Suitable fixing devices include a retaining bracket, retaining eyelet, retaining strap, or cable lug. When using the rotary joint for a holding device, further holding segments are connected to the joint parts, wherein fixing devices can preferably be provided at the distal ends of the joint parts. Furthermore, fixing devices can be provided on the respective adjacent holding segments as an alternative or in addition to fixing points on the corresponding joint parts. The fixing can be configured in such a way that a movement of the supply line parallel to the longitudinal axes of the joint parts in each case is still possible. Here, a supply line which is fixed in the longitudinal direction of the holding segment has a free length of, for example, at least 5 mm, so that the play of the supply line ensures a relative movement of the joint parts.

It should be noted that the rotary joint for holding devices can be used in other areas of application besides human and veterinary medical applications. It is essential that the device to be positioned with the rotary joint can be pivoted in as many directions or angular positions as possible, wherein excessive twisting of the joint parts relative to each other should be avoided. This can be used, for example, when positioning technical devices such as lighting devices or camera systems in order to be able to specifically illuminate or examine certain areas or difficult-to-access technical cavities.

For easy pivoting relative to each other, the first joint part preferably comprises a convexly shaped surface, and the second joint part comprises a concavely shaped surface as a bearing surface, so that the two mutually facing surfaces are adapted to each other and can be engaged with each other with the exception of the surfaces of the recesses. The recesses and the roller bodies are configured such that the one or more roller bodies form one or more floating elements between the two joint parts, which equally engage the corresponding inner walls or inner surfaces of the recesses in both joint parts. The roller body interacts with both joint parts to act as a rotation control element.

The recesses are configured in such a way that they take up only a small area of the corresponding joint parts, so that at least 80% of the remaining area is available to engage with the contact surface of the other joint part in each case. If the joint is configured as a ball joint, there thus remains enough engaged surface area around the recesses to maintain the function of the ball joint. In order to be able to lock the ball joint firmly, the first joint part can be locked by displacement of a thrust element and by frictional engagement on its outer surface. When locking the ball joint, it is advantageous to have as large a contact surface as possible with the distal end of the thrust element.

Both joint parts have a recess or pocket, wherein the preferably concave bearing surface or bearing shell has a central recess. A preferably at least partially convexly curved first joint part is positively enclosed by the bearing shell, wherein there is no direct contact between the first and second joint parts at the level of the central recess. At the level of the recesses of each of the joint parts, the contact between the joint parts can only be established indirectly, i.e., exclusively by means of the roller body.

The at least partially convex first joint part preferably has at least one elongated, longitudinal recess. Furthermore, the recess has, transverse to its longitudinal axis, a cross-sectional curvature, which is adapted to the outer diameter of the roller body for optimal accommodation of the roller body. In this way, the possible contact area of the roller body with the first joint part and the play of the roller body transverse to the longitudinal axis of the recess can be minimized. This makes it possible to take advantage of a relatively large contact surface between the first joint part as the bearing element and the second joint part as the bearing shell.

According to a preferred embodiment, the angle ranges of the corresponding recesses are summed.

In other words, the roller body can move along the elongated recess of the first joint part and also in the preferably circular recess of the second joint part, so that the maximum path that can be traveled is along the maximum longitudinal extension of the first joint part and along a diameter of the inner running surface of the recess of the second joint part. In this way, the two joint parts can be rotated relative to each other in a path-controlled manner.

In a preferred embodiment, the permitted predetermined total possible angular rotation is between 120° and 340°, in order to exclude over-rotation beyond 360°. In an even more preferred embodiment, the device can allow only movements of the joint parts relative to each other in a smaller angle range of between 140° and 270°.

Since the angle ranges of both recesses are summed, the recesses on the first joint part can be made relatively narrow and thus enable a stable clamping. In this way, recesses that are too large on only one joint part and the associated impairment of stability during rotation or after locking after a clamping can be avoided.

According to a preferred embodiment, the device comprises at least one second roller body, wherein both joint parts each have a second recess for guiding the corresponding second roller body.

Preferably, the first recess and the second recess are arranged opposite one another on the corresponding joint part.

If a spherical head part with a joint neck is provided for the first joint part, the recesses of the first joint part are arranged mirror-symmetrically to the longitudinal axis of the joint neck. Due to this symmetrical arrangement of two recesses in the first and second joint parts, a roller body can be arranged on both sides between the joint parts. This arrangement prevents any undesirable tilting movements that would be possible if the recess were arranged only on one side in each of the joint parts. Furthermore, this symmetrical arrangement prevents possible uneven wear of the bearing shell or of the second joint part, and allows possible manufacturing tolerances to be better compensated.

In order to be able to lock the device firmly in different angular positions, according to a preferred development, the first joint part can be locked by frictional engagement on its outer surface. For this purpose, a holding segment is preferably connected to the second joint part by means of a connecting element, wherein the holding segment has a thrust element. The thrust element can be configured as an axially movable push rod and extends into the connecting element and through an opening of the second joint part in order to act to clamp or lock in the event of a longitudinal axial displacement in the distal direction, i.e., in the direction of the first joint part.

According to a preferred embodiment, the first joint part is configured as a spherical-segment-shaped head part, and the at least one first recess is configured as a longitudinal outer groove with two stops along the spherical equator and comprises an angle of less than 70°, wherein the remaining protruding outer surface of the first joint part is available for engagement with the inner surface of the second joint part. If the maximum travel path L1 of the first joint part corresponds to an angle range of 70°, this, together with an equally dimensioned travel path of the circular recess of the second joint part, can together allow a predetermined angular rotation of 140° of the rotary joint. Other angle ranges up to about 270° are conceivable, depending upon the rotation limitation requirements.

In a preferred embodiment, the first joint part can have a spherical-segment-shaped head part and thus a partial spherical surface. The partial spherical surface can be rotatably mounted in the second joint part, which can be configured, for example, at least as a hemispherical bearing shell. The partial spherical surface or spherical segment outer surface is preferably enclosed by the bearing shell in a form-fitting manner. The partial spherical surface or the spherical-segment-shaped head part of the first joint part has at least one elongated recess on its outer surface, which runs longitudinally with respect to a tangent. Preferably, the recess can extend along the horizontal line (equator line) which is arranged transversely to an axis, extending from the head part, of a joint neck. By providing a narrow outer groove adapted to the roller body cross-section, a large engagement surface remains, which can also be used for frictional clamping.

Both joint parts have a recess or pocket. According to a preferred embodiment, the at least one corresponding recess of the second joint part is configured as a circular inner running surface with a circumferential stop edge.

In other words, the concave, preferably at least hemispherical bearing surface or bearing shell has a recess with a circular shape, along whose inner running surface the roller body can move. A roller body can travel at most the length L2 along the curved path parallel to the inner diameter of the circular surface in one direction. The outer diameter of the circular surface is at least larger by the radius of a spherical roller body in order to provide a curved stop edge adapted to the roller body. The one or more roller bodies can equally interact or engage with the said groove-shaped recess of the first joint part and the circular recess of the second joint part, and, in this way, the achievable angular freedoms of the recesses sum to a predetermined maximum total angular rotation.

According to a preferred embodiment, the corresponding recesses are in total deeper than the outer diameter of the corresponding spherical roller body.

Because the recesses or pockets are slightly deeper than the roller bodies used, the roller bodies cannot jam and do not interfere with the smooth movement of the joint. The roller bodies which serve as stop balls can preferably have a diameter of 2 mm or a radius of 1 mm, wherein the diameter of the semicircular cross-section of the outer groove and the corresponding radius of the first joint part are larger than 2 mm or 1 mm. Furthermore, the recess in the second joint part is deeper than half the diameter of the roller body. Other dimensions than a 2 mm diameter of the roller bodies are also conceivable, and depend upon the dimensioning of the joint.

According to a preferred embodiment, the first joint part is a spherical-segment-shaped head part with a joint neck, and the second joint part is a joint shell which overlaps the spherical equator in a non-angled position of the joint and is configured in two parts to accommodate the head part.

In this way, a ball joint can be provided, preferably for a holding device. Additional holding segments of a holding device can be connected to the joint neck or the joint shell.

According to a preferred embodiment, the joint shell has at least one opening on its outer edge for receiving the joint neck of the first joint part in order to be able to angle the axis of the joint neck up to 90°.

In this way, in the ball joint according to the invention, a rotation about the joint neck axis of the first joint part can be restricted without reducing the previous angular movement capability of +/−90°, compared to a ball joint with unrestricted freedom of movement.

According to a preferred embodiment, at least one second recess of the joint shell is circular, and its center extends on a common axis m with the center of the first recess in order to provide a symmetrical and thus stable arrangement.

According to a preferred embodiment, the second joint part can be connected via a connecting element to a holding segment in which an axially displaceable thrust element is arranged. The second joint part has a central opening to guide the distal end of the pushing element through and in this way to selectively lock the first joint part by means of a distal displacement of the pushing element or to release it by means of a displacement in the proximal direction, i.e., away from the outer surface of the first joint part.

Furthermore, a system is provided which, as a preferred embodiment, comprises a holding device with at least one distal holding segment or handle for a medical device and a proximal holding segment, each of which can be coupled to a rotary joint, wherein the rotary joint has a device for limiting its mobility according to one of the preceding claims. The system further comprises a supply line for the medical device, which is guided from the first joint part to the second joint part, wherein a limitation of the mobility of the first joint part relative to the second joint part prevents damage to the supply line due to wrapping and/or tensile loads.

According to a preferred embodiment, the rotary joint is a ball joint, and the joint shell is connected to the proximal holding segment. The proximal holding segment has an axially displaceable thrust element to frictionally lock the head part of the first joint part of the rotary joint.

According to a further aspect of the invention, a method for limiting the mobility of a rotary joint is provided, comprising the following method steps:
providing a two-part rotary joint with at least one recess in each joint part for at least one roller body;
guiding the at least one roller body between the joint parts in the corresponding recesses of the two joint parts; and
limiting movement of the joint parts relative to one another due to the mobility of at least one roller body within the corresponding recesses until stop positions are reached.

According to a preferred embodiment, the method further comprises the following method steps:
connecting the second joint part via a connecting element to a holding segment in which an axially displaceable thrust element is arranged;
optionally locking or releasing the first joint part, wherein, for locking by means of frictionally engagement, an axial displacement of the thrust element in the holding segment takes place through a central opening in the direction of the outer surface of the first joint part, and wherein, for releasing, an axial displacement of the thrust element away from the outer surface of the first joint part takes place.

In the locked position of the joint, an outer surface of the first joint part can be frictionally secured to a contact surface of the second joint part via the thrust element by means of clamping tension. In the released position of the joint part, the outer surface of the first joint part functions as a running surface which engages with the corresponding contact surface of the second joint part, which is preferably configured as a joint shell or a ball segment socket. The aforementioned positions can be easily adjusted by moving the thrust element towards or away from the outer surface of the first joint part.

According to a preferred embodiment, the method further comprises the following method steps:
fixing a supply line to the first joint part and to the second joint part and/or to at least one further holding segment by means of fixing devices.

Here, limiting the mobility of the first joint part relative to the second joint part prevents damage to the supply line due to wrapping and/or tensile loads.

According to a preferred embodiment, the following method steps are carried out before the provision of the two-part rotary joint, which is configured as a ball joint and comprises a spherical-segment-shaped head part as the first joint part and a joint shell, which can be separated for assembly, as the second joint part (220):
inserting the first joint part with the at least one roller body into a lower part of the joint shell, wherein the joint neck of the spherical-segment-shaped joint part is guided out of the joint shell; and
enclosing the spherical-segment-shaped joint part with an upper part of the joint shell.

In this way, a spherical-segment-shaped first joint part can be inserted into the lower part and then closed by the upper part of the joint shell. The terms “upper” and “lower” are not to be understood as limiting, such that the practical assembly can also be carried out in the reverse order. It should be noted that, in an embodiment with two circular recesses of the second joint part, the dividing plane between the upper and lower parts runs through the center of the circular area of the two recesses.

According to a preferred embodiment, the method further comprises the following method steps:
providing one or two openings in the outer edge of the joint shell to accommodate the joint neck, and
angling the axis of the joint neck of the first joint part by up to 90°.

The ability to be angled allows for greater mobility and ensures better handling of the joint for an operator. Here, two openings are positioned so that they are symmetrical to each other and opposite each other in the joint shell. If, in addition, two recesses are arranged in the bearing shell, the centers of each of the two circular pockets are also arranged opposite one another in the joint shell, so that the centers lie on an axis m, wherein the center axis m runs transversely to the outgoing longitudinal axis b of the second joint part and is also part of the plane of symmetry of the symmetrically arranged openings. Due to the symmetrical arrangement of the openings and recesses to one another, running surfaces or engagement surfaces for the outer surface of the first joint part remain on both sides of the openings, evenly distributed over the joint shell. This ensures the stability of the joint when the joint parts move relative to each other. There is also sufficient area for locking, in order to establish a reliable and stable frictional connection between the first joint part and the second joint part.

The invention, as well as further advantageous embodiments and developments thereof, are described and explained in more detail below with reference to the examples shown in the drawings. The drawings are for illustration purposes only and are not to scale. Terms such as ‘top’ or ‘bottom,’ upper or lower part, directions or orientations of axes shown in the figures, are not to be understood as limiting, since the joint or parts thereof are not fixed to the shown position in space. Identical reference signs indicate the same elements in the figures. The features to be learned from the following description and the drawings can be used according to the invention individually or in groups in any combination without departing from the scope of the present disclosure. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of a first joint part according to the invention;

FIG. 2a is a schematic perspective detailed view of a second joint part, which is configured as a bearing shell for a ball joint;

FIG. 2b, FIG. 2c, and FIG. 2d are partial views of the second joint part to illustrate the structure and function;

FIG. 3a is a schematic perspective view of a device according to the invention for limiting mobility comprising a first joint part and a second joint part, which is only partially shown for illustration purposes;

FIG. 3b and FIG. 3c are sectional views of the device, wherein the second joint part connected to a holding arm is only partially shown for illustration purposes, and the first joint part is shown in different stop positions;

FIG. 4a and FIG. 4b are perspective sectional views showing the device in further stop positions, wherein the holding arm is shown open to illustrate the internal thrust element;

FIG. 5 is a side view showing a part of a holding device, wherein the holding arm connected to the second joint part is configured as a spherical shell which receives a corresponding spherical-segment-shaped first joint part with a handle part on the outgoing axis;

FIG. 6 is a diagram showing an exemplary embodiment of a method according to the invention for limiting the mobility of a two-part rotary joint; and

FIG. 7 is a diagram showing a further embodiment of a method according to the invention, wherein the second joint part of a ball joint is provided in two parts in order to be able to insert the first joint part during assembly.

### DESCRIPTION OF PREFERRED EMBODIMENTS

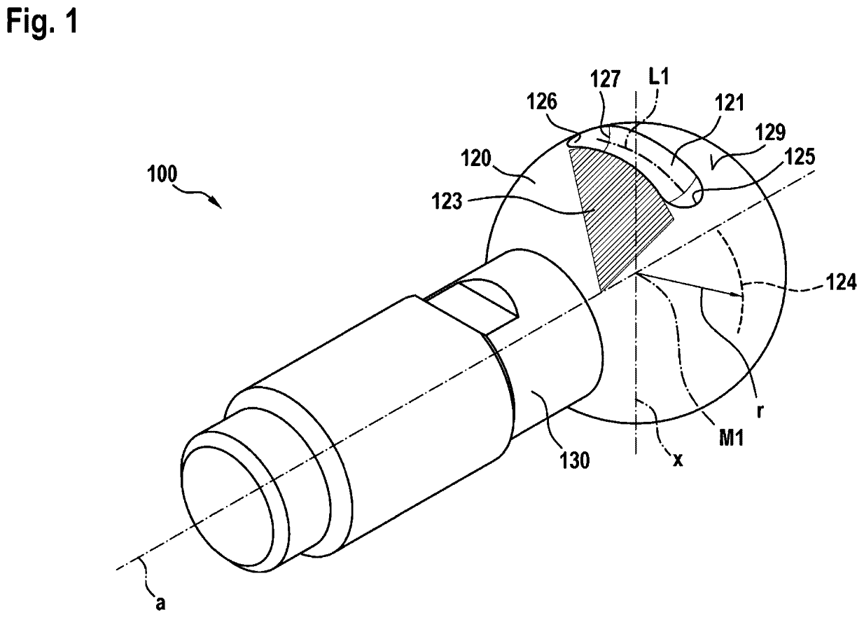

Referring to the drawings, FIG. 1 schematically shows a first joint part 120 of a ball joint according to the invention. The first joint part 120 together with the joint neck 130 form a joint unit 100. The joint neck has a central axis a, and the spherical-segment-shaped head part which forms the first joint part 120 has a center point M1 at the intersection of the longitudinal axis a and the vertical central axis (marked with axis x) through the spherical-segment-shaped head part. The spherical-segment-shaped head part 120 has an outer surface 129 which functions as a running surface or engagement surface and in which at least one recess 121 is arranged. The recess 121 is elongated and runs in the direction of the spherical equator 124. The outgoing axis a of the joint neck 130 runs perpendicular or at a right angle to the equatorial plane and thus perpendicular to the shown sphere radius r, which spans the sphere equator.

The recess 121, which is configured as a longitudinal outer groove, has a stop 125 or 126 at both ends. The recess 121 forms a track of length L1 for a spherical roller body and has a curved cross-section 127, the curvature of which is adapted to the outer geometry of the at least one spherical roller body (not shown here). Preferably, the radius of the cross-section 127 is somewhat deeper than the spherical radius of the roller body, or the curvature of the cross-section 127 is slightly larger than the outer diameter of the corresponding spherical roller body. In this way, the limiting balls or roller bodies can run smoothly in the groove-shaped recess 121 without jamming. This advantageously ensures that the joint moves smoothly. In other words, a roller body can simply slide along the length L1 and the walls of the recess 121 until the stops 125 and 126 are reached. Due to the curved end stops, the running length L1 is shorter than the entire longitudinal extension of the recess 221 at the level of the outer surface.

The maximum mobility along L1, i.e., along the curved longitudinal center line at the bottom of the channel-shaped recess 121, corresponds in the case shown to a predetermined limited angle range, which is indicated here with the reference sign 123. Angle ranges other than the one shown of about 60°-70° are also conceivable. Depending upon the choice of the selected angle 123, the mobility of the ball joint can be limited to a greater or lesser extent. If two recesses of length L1 are provided opposite one another, the length L1 can cover an angle range of less than 120° in each case, preferably less than 90°, and particularly preferably less than 70°.

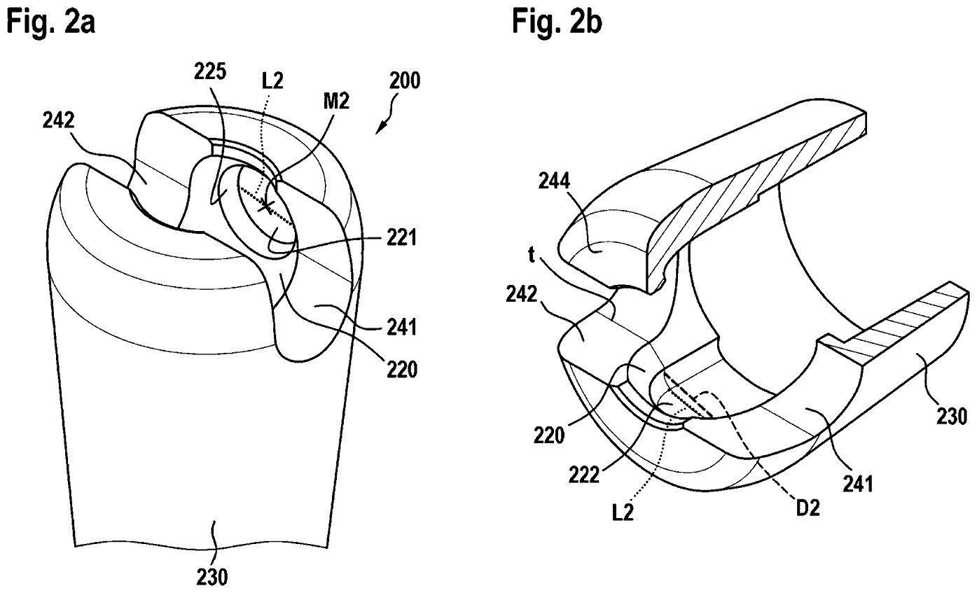

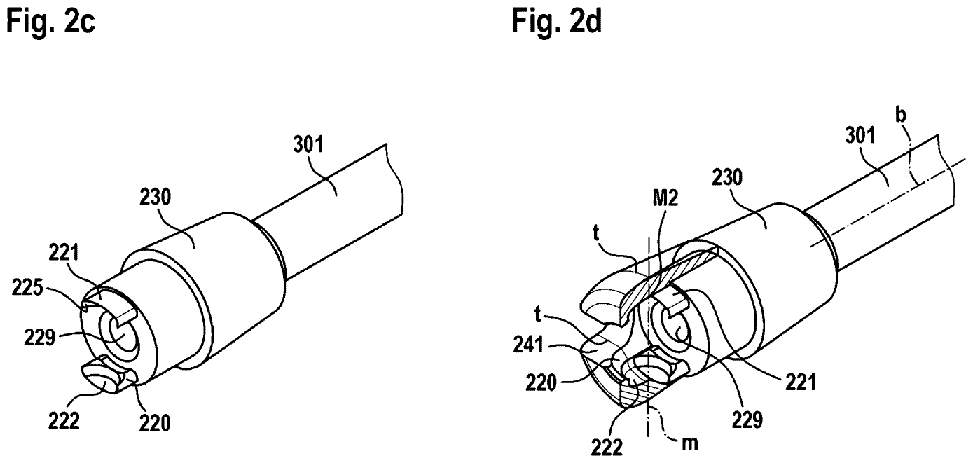

FIG. 2a, FIG. 2b, and FIG. 2c show the second joint part, wherein FIG. 2b and FIG. 2c each show a perspectival detail view of the second joint part 220, which is shown with partial cross-sections for better illustration. FIG. 2d shows another fragmentary, perspectival picture of the second joint part. The second joint part 220 forms a joint unit 200 together with the connecting element 230.

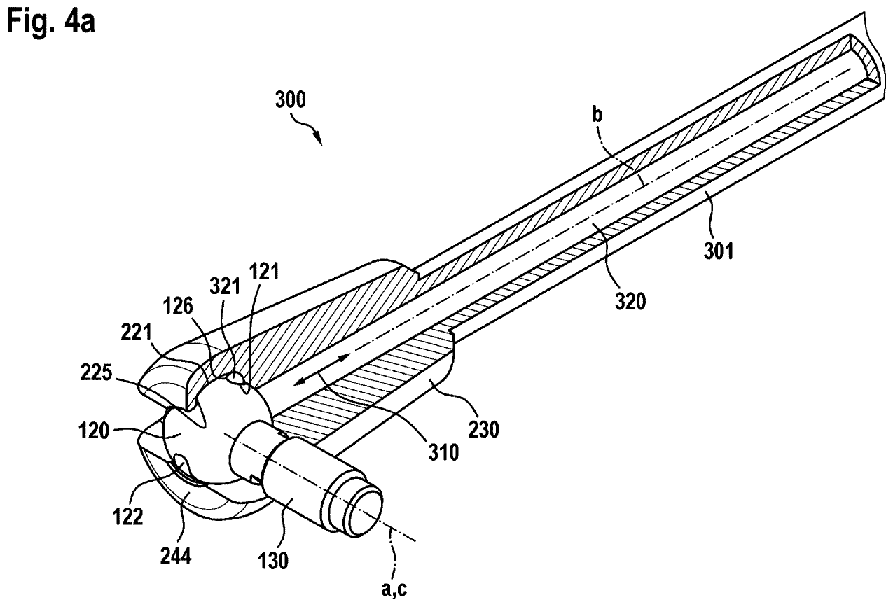

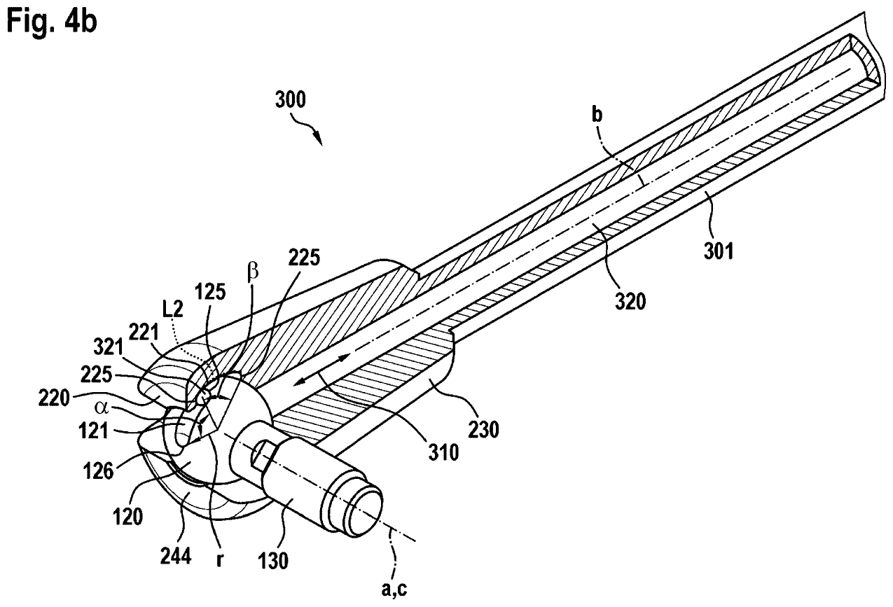

FIG. 2a shows the second joint part 220 with a recess 221 which corresponds to the floating element or the roller bodies (not shown) with the other recess 121 (not shown) of the first joint part 120 (not shown). Like the recess 121 in the first joint part 120, this recess 221 also has a stop 225. Since the recesses 221, 222 are circular, in each case a circular inner running surface is created on the bottom for the corresponding roller body 321 with a circle center M2 (see x in FIG. 2a). Each recess has an inner track L2 (dotted line, which is adapted to the curvature of the joint shell; see also L2 in FIG. 4b) and a circumferential stop 225, as well as an outer edge diameter D2 (dashed line) which is larger than the inner diameter of the circle. The depth of the recess 221 and the curvature of the stop edge 225 are each selected such that the roller body can run optimally in this recess 221. Preferably, the curvature of the stop edge 225 is slightly larger than the outer curvature of the roller body 321, which is preferably spherical. In order to prevent jamming and to ensure smooth movement of the roller bodies 321, the depth of the recesses 221, 222 is deeper than the radius of a spherical roller body.

The length L2 (dotted line through center M2) is at least the maximum cross-section of the inner circle, and runs through the center M2. The running length L2 depends upon the corresponding curvature of the running path and is therefore longer than the diameter of the inner circular surface of the circular recess 221. The running surface of the roller body in the recess 221 is also limited by the curved outer edge or stop.

If one assumes a path along the dotted length L2 in the recess 221 of the second joint part 220, with the length L1 of the first joint part (see FIG. 1), there results a maximum travel distance L1+L2 that the roller body can travel in one direction. The length L1 and length L2 each correspond to a predetermined angle range, wherein the angle ranges of the corresponding recesses 221 and 121 are summed. The lengths L1 and L2 can be approximately equal.

In one exemplary embodiment, the lengths L1 and L2 of the recesses 121, 221 correspond to an angle range of 70° each. In this example, it is possible to rotate the first joint part 120 about its outgoing axis by a total of approximately 140°. The provision of the symmetrically arranged second recess 222, which corresponds to a recess 122 of the first joint part, serves to stabilize the joint and is dimensioned in exactly the same way as the first recess 221 in order to limit the movement in exactly the same way as the opposite recess 221.

While the opposite recesses 221 and 222 of the second joint part 220 must be of the same size (each with the same cross-sectional length L2 in FIGS. 2a and 2b), it is possible to make the length L1 of the recesses 121, 122 corresponding to these recesses 221, 221 the same size as L2 or variable, depending upon the desired limitation. The latter means that the length L1 can be chosen to be shorter or longer than the length L2. Thus, in one exemplary embodiment, the inner running path L2 of the circular recess 221 can be selected to be less than the length L1 of the groove-shaped recess 121 in order to be able to provide more protruding running surface between the openings 241, 242 and the central opening 229 as well as the recesses 221 for the outer surface of the first joint part 120 (not shown).

If two recesses of length L2 are provided opposite one another, the length in each case should preferably correspond to an angle range of less than 90°, preferably 70°. The smaller the angle ranges and associated lengths of both recesses 221, 121 are selected to be, the less a supply line attached to each joint part twists, so that the supply line can be attached with less play between the two joint parts.

The second joint part 220 is configured as a joint shell or ball segment socket, wherein the outer edge 244 of the joint shell has at least one opening 241. The embodiment shown shows a further opening 242 on the opposite side. The openings 241 and 242 are configured such that they can receive a joint neck 130 of the first joint part 120. In this way, the head part of the first joint part 120 can be angled together with the joint neck up to 90° (see also FIG. 4a for the illustration of an angled position).

While FIG. 2a shows a connecting element 230 together with the second joint part 220, FIG. 2b shows a further perspectival view, wherein the joint shell is partially broken open for better visualization, and the connecting element 230 is shown shortened. In FIG. 2b, the joint shell or the second joint part 220 is shown with a complete opening 242 and a partially broken-away second opening 241, which also only partially shows the circumferential high edge 244.

FIG. 2c shows a further illustration of the embodiment of the second joint part 220, wherein, in addition, a holding arm 301 is shown which can be connected to the distal end of the connecting element 230. The front visible part of the second joint part 220 shows that two recesses 221 and 222 are arranged opposite and symmetrical to each other. Furthermore, it can be seen from FIG. 2c and FIG. 2d that a central opening 229 is arranged at the base of the second joint part 220.

FIG. 2d also shows a dividing line t, which runs from the opening 241 centrally, i.e., through the center, through the recess 222. The two recesses 222 and 221 in the bearing shell are arranged so that the centers of the two circular pockets in the joint shell are opposite each other. The center points (M2 in 221) lie on the dot-dashed line, i.e., the vertical axis m, wherein the center axis m runs transversely to the outgoing longitudinal axis b of the second joint part 220. The dividing line t runs through both centers.

This dividing line t indicates that the second joint part 120 is manufactured in two parts. Thus, during assembly, the part (e.g., called the lower part when oriented as in FIG. 2a) that can be connected to the connecting element 230 can be provided first. The first joint part 120 can then be inserted into this half-open joint shell segment. In a next step, a further part (e.g., called the upper part, if the orientation is as in FIG. 2a) of the joint shell 120 is then used for final closure. The hemispherical ball segment socket of the upper part should be connected to the other part in such a way that no joints or elevations are created that could interfere with the running of the roller bodies. After completion of the assembly (not shown), a spherical storage space is provided which in part has openings, in particular comprising the central opening 229 (see FIGS. 2c and d) and the openings 241 and 242 (see FIG. 2a, b, and d).

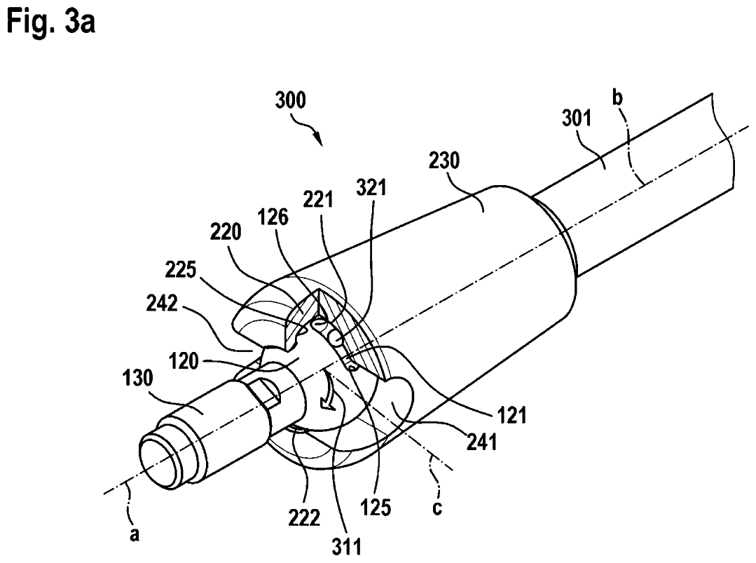

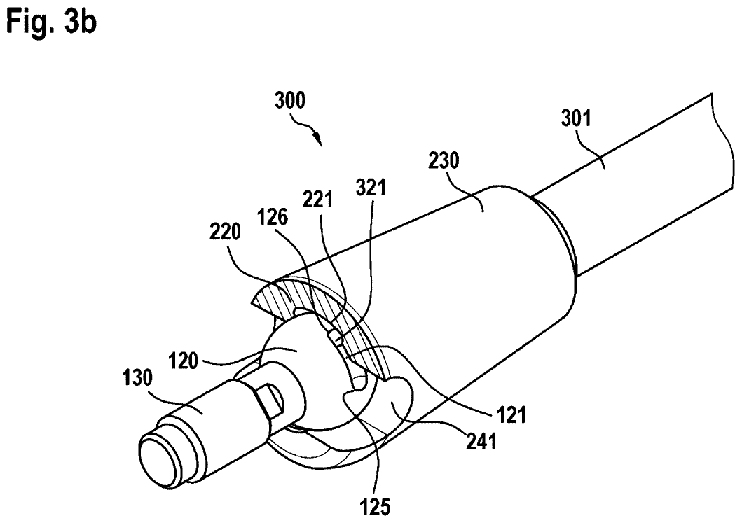

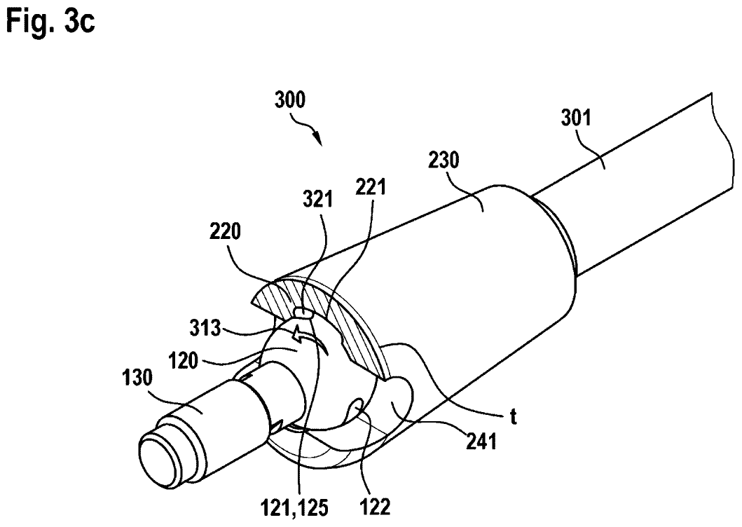

FIG. 3a shows the entire joint 300, which is configured as a ball joint and comprises the first joint part 120, the second joint part 220 with a connecting element 230, a holding arm 301, and roller bodies 321. The joint part 220, which is configured as a partially spherical joint shell, is partially cut open in order to better show the spherical-segment-shaped head part of the first joint part 120 moving therein. A roller body 321 is arranged between the first joint part 120 and the second joint part 220 and the corresponding recesses 121 and 221. The further roller body is located on the opposite side of the first joint part 120 (not shown).

The joint neck 130 on the first joint part 120 has the outgoing axis a, which is oriented such that it is aligned with axis b, which is the outgoing axis of the second joint part 220 and at the same time the longitudinal axis of the holding element 301 connected thereto. Therefore, the b axis is shown by the same dot-dashed line as the a axis. Another dot-dashed line indicates an axis c, which runs at 90° to the support arm axis b.

The arrow 311 indicates a possible rotational movement around the central axis a of the joint neck to the right in a clockwise direction. The roller body 321 forms an intermediate element or so-called floating element between the second joint part 220 and the corresponding recess 121 of the first joint part 120. In the illustration shown, the roller body 321 is in the stop in the circular recess 221 of the joint shell or of the second joint part 220. As the arrow indicates, the first joint part 120 can be rotated further to the right about its axis a up to the stop 126 on the left side. Alternatively, and here not indicated by an arrow, the first joint part 120 could also be rotated counter-clockwise around the axis a until the roller body would be limited by the stop 125 (see FIG. 3c).

With the help of the stops 125 and 126 or the stop 225 configured as a circumferential edge, the movement of the first joint part 120 to the second joint part 220 can be restricted by means of the roller bodies 321 which can be moved in the recesses. This limits the free pivotability of the ball joint. If a cable runs along the support arm and is connected to the joint neck 130 of the first joint part 120, this prevents the cable from unnecessarily twisting and being wound around the axis a or axis b.

Furthermore, the provision of the openings 241 and 242 enables the joint neck to be angled 90° to the right or left perpendicular to the axis a. The dot-dashed line or axis c shows, for example, the constellation when a 90° angle is made to the support arm axis b, as shown in FIG. 4a.

FIG. 3b shows the same embodiment as shown in FIG. 3a, but after the clockwise rotation indicated by the arrow 311 has been performed. In this position, the roller body 321 is now in the stop, viz., between the stop point 126 of the first recess 121 and the stop of the recess 221 of the second joint part.

FIG. 3c shows a further position of the first joint part 120 in the second joint part 220. Here, not only the first recess 121 can be seen on the first joint part 120, but also an oppositely situated second recess 122. Both recesses correspond to a respective recess 221, 222 of the second joint part 220 configured as a joint shell. The schematic arrow 313 indicates the direction of rotation, wherein further rotation in the clockwise direction is no longer possible, since the roller body 321 is in the stop position against the stop 125 of the groove-shaped recess 121. In other words, the first joint part 120 can no longer be rotated clockwise about the axis a.

The recess 221 and the second recess (not shown) of the second joint part 120 or the joint shell are circular. The center point or the central axis m (not shown here) runs at the level of the dividing line t or the dividing plane that divides the joint shell into upper and lower parts. The part of the joint shell or the second joint part 220 shown here forms a partially spherical bearing space with recesses 221, 222 and openings 241, 242 as well as opening 229 (not shown).

FIG. 4a shows a second joint part 220 with a holding arm 301 in which a thrust element 320 is arranged. The thrust element can be moved along the axis b. This is indicated by the arrow 310. This allows a displacement in the direction of the spherical surface and a locking of the ball joint. In this case, the thrust element 320 is pushed through the central opening 229 (here covered by the first joint part) of the joint shell 220 along the axis b far enough that the end of the thrust element 320 can touch the joint ball and exert a clamping force. In this way, when the thrust element 320 is displaced in the direction of the outer surface of the head part of the first joint part 120, a frictional engagement and thus a locking of the entire ball joint can take place.

Furthermore, FIG. 4a shows an angled position of the first joint part 120 with the associated joint neck 130. The longitudinal axis a of the joint neck 130 is in this case angled approximately 90° with respect to the holding arm axis b so that it is aligned with the axis c. In other words, the joint neck 131 can be moved from a position in which its outgoing axis a runs parallel to the longitudinal axis b of the connecting element 230, at the level of the openings 241 or 242, into a transverse position, so that it is angled by up to 90° with respect to the axis b. However, this angling is not possible in the regions of the joint shell in which no lowering of the edge by an opening 214, 242 is provided.

In the angled position of the first joint part 120 shown, two opposing groove-shaped recesses 121 and 122 are visible, each of which serves to guide a roller body 321. The roller body 321 visible in this figure is clamped between the stop 126 of the recess 121 and the circumferential stop 225 of the circular recess 221. As a result, further clockwise rotation around the axis a is no longer possible, and the movement is thus limited.

FIG. 4b shows an angled joint neck 130, with the joint neck axis a extending transversely to the axis b of the thrust element 320, as in FIG. 4a. In contrast to FIG. 4a, FIG. 4b shows a different stop position in the circular recess 221 with the diameter D1, after the first joint part 121 has been rotated counter-clockwise about the axis a. In the stop position shown, the roller body 321 is clamped between the stop 125 and the stop 225 of the recess 221 of the joint shell 220. In this way, the clockwise movement is limited. In this way, an excessive rotation in the same direction can be prevented.

The angular rotation of the spherical-segment-shaped head part about the joint neck 130, i.e., about the axis a or c in the 90° position shown, is limited within a predetermined angle, wherein a further rotation in the clockwise direction is initially possible according to the angle β, which corresponds to the length L2 of the diameter D1 of the circular recess 221. While the roller body 321 is held at the stop 225 on the holding arm side of the recess 221 during a further clockwise rotation, a further rotation can take place according to the angle α or the running length L1 of the groove-shaped recess 121. This means that the angle ranges α and β of the corresponding recesses 221 and 121 are summed.

Not shown in FIG. 4b is the second recess 222, which is situated opposite and has the same geometry and diameter D1 as the recess 221. Here, a further second roller body 321 is provided, which, due to the symmetrical arrangement, experiences the same limitation with a corresponding stop as the first roller body 321. As explained above, in the 90° angled position shown, the rotational movements can be only in the clockwise direction from the stop position shown in FIG. 4b.

Furthermore, all rotational movements can be prevented if the thrust element 320 is moved according to the arrow 310 in the direction of the outer surface of the spherical-segment-shaped head part of the first joint part 120 for locking, and thus a clamping force presses the contact surfaces of the two joint parts 120 and 220 against each other. In other words, the joint 300 shown can be used in two modes of operation. On the one hand, in a locked position, and, on the other, in a released position, wherein the rotation of the first joint part 120 in the second joint part 220 is limited by the predetermined angles of the corresponding recesses 121 and 221. In this way, excessive loads on supply lines can be avoided.

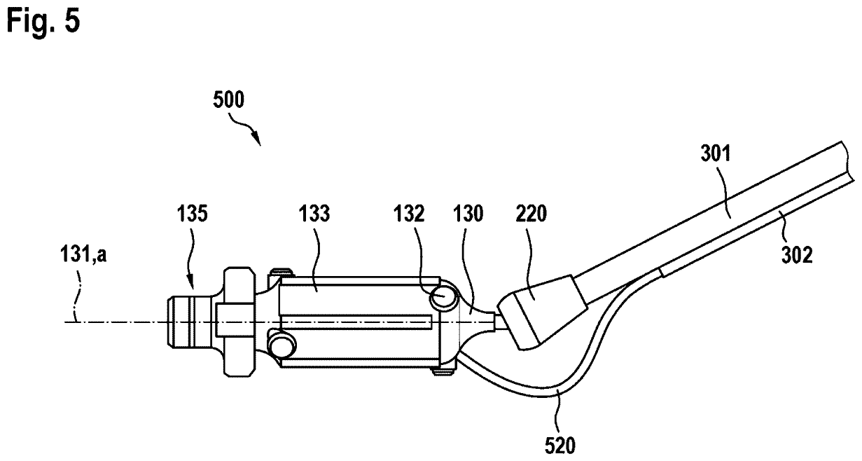

FIG. 5 shows the part of a holding system 500 with a device according to the invention for limiting the mobility of a rotary joint 300, with an exemplary supply line 520. The support arm 301 is only partially shown and can be connected to additional support segments or a base column. A thrust element can be provided in the holding arm 301, which element is configured to clamp or lock the first joint part 120 in the joint shell 220.

The first joint part 120 is not shown in this representation of FIG. 5, and is preferably configured as a spherical-segment-shaped head part. The joint neck 130 connects the first joint part 120 to a distal handle 133 with a handle axis 131 which is aligned with the joint neck axis a. The distal region of the holding system 500 is the region furthest away from the proximal region, i.e., the holding arm 301. A coupling device 135 is provided on the distal side of the handle 123. For example, a medical instrument can be attached to the coupling device 135. A preferred embodiment of a coupling unit 135 is, for example, a quick-coupling unit. Suitable quick-coupling units are autoclavable and are configured to connect various medical instruments. Examples of medical instruments are endoscopes, exoscopes, cameras, but also micro scissors, forceps, tweezers, punches, or the like. Many of the medical instruments also require a supply line 520 to supply power and/or control from the support arm 301 leading to the handle 123. With the aid of one or more buttons 132, an end effector connected to the holding system 500 can be electronically activated or deactivated via the supply line 520. For patient safety, the actuating elements 132 can activate the locking mechanism only if all buttons 132 are pressed simultaneously. In this way an accidental activation of components of the holding system 500 can be excluded.

The cable 520 is partially fixed to the holding segments and/or the joint parts by means of fixing devices 302. In the example shown, a cable lug is provided as a fixing device 302 for fixing to the holding segment or holding arm 301. The fixing device 302 is configured to hold the supply line 520 on the holding arm 301 at a position of the outer circumference of the holding arm 302. In this case, a movement of the supply cable in the direction of the holding arm axis b can be prevented or a certain movement of the cable in the longitudinal direction parallel to the holding arm 302 can be enabled in order to allow play of the cable when the joint is angled.

With the help of the limiting device, the supply line 520 twists in the form of a cable and is prevented from winding around the holding arm 301 or the handle 123. Due to the device for limiting the mobility of the rotary joint, the angular rotation of the handle 123 about its axis 131 or the joint neck axis a in relation to the holding arm 301 can be limited to within a predetermined angle. A rotation of the ball joint over 360° is thus no longer possible. By limiting the angle to a predetermined angle range around the joint neck axis, entanglements and thus damage to the supply line 520 cannot occur. In particular, when there is a symmetrical arrangement of two recesses 121, 122 or 221, 222 on each joint part 120, 220 and associated stops and roller bodies 321, the stability and thus the ergonomics of the holding system 500 are improved, since the user is given a feeling of high quality and a solid instrument. Differing from what is shown in FIG. 5, the supply line 520 can also be partially guided inside the holding segment 301. In the illustration shown in FIG. 5, the supply line enters the handle 123.

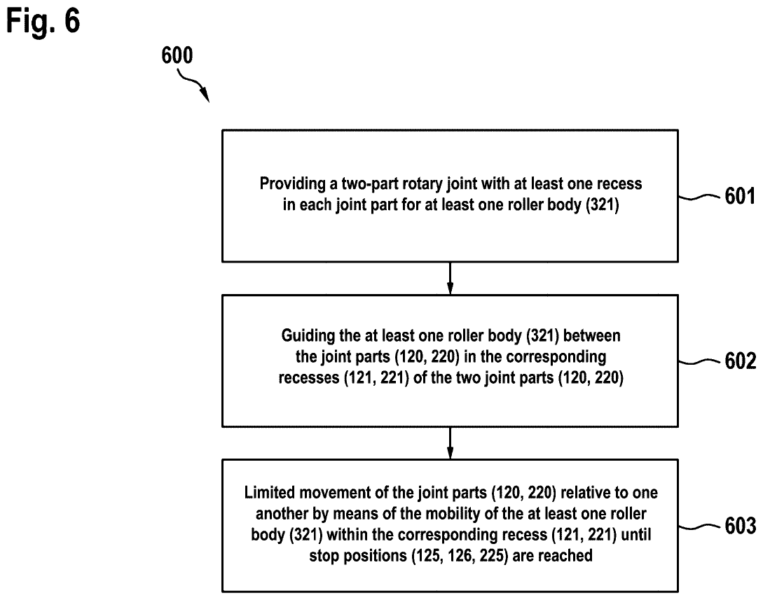

FIG. 6 shows a method 600 according to the present invention. As a first method step 601, a two-part rotary joint with at least one recess in each joint part for at least one roller body is provided. In the second method step 602, the at least one roller body 321 is guided between the joint parts 120 and 220 in the corresponding recesses 121 and 221 of the two joint parts 120 and 220.

Finally, in method step 603, the movement of the joint parts relative to one another is limited by means of the mobility of the at least one roller body within the corresponding recesses. The joint parts 120, 220 can move relative to one another within a predetermined limited angle range, in that the at least one roller body moves within the corresponding recesses until the stop positions 125, 126, and 225 are reached. This ensures that rotation and thus torsion control can be exercised to ensure that the joint parts cannot rotate more than 360° relative to each other. This can reduce the risk that a supply line for an end effector, which is fixed or guided for example in the form of a cable from the first joint part to the second joint part and by means of fixing devices, is damaged or separated by over-rotation of the joint parts relative to one another. In this way, any type of supply line which can be used as, inter alia, data lines, control lines, and/or lines for fluids or gases, can be protected from excessive stress.

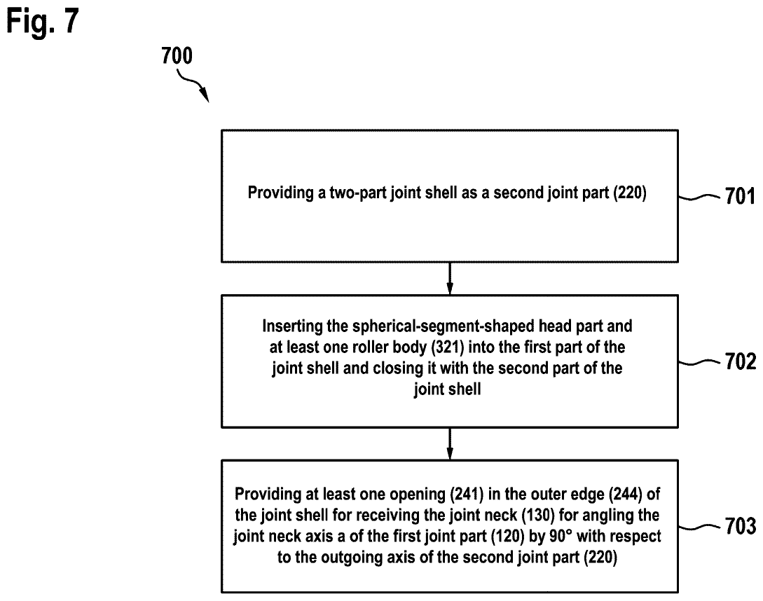

FIG. 7 shows a method 700 according to the present invention. This comprises, as a first method step 701, the provision of a two-part joint shell as a second joint part 220 with preferably at least two running surfaces. As the next method step 702, the first joint part 120, configured as a spherical-segment-shaped head part, and at least one floating element or roller body 321 are introduced into a first part (e.g., lower part) of the second joint part 220 configured as a joint shell. Closing then takes place by a second part of the joint shell.

In an optional method step 703, one or two openings 241, 241 can be provided in the outer edge of the joint shell of the second joint part 220 in order to accommodate the joint neck 130 of the first joint part 120, and thus to enable it to be angled with respect to the outgoing axis b of the second joint part 220.

Finally, the joint parts 120, 220 can be moved relative to one another within a limited angle range by means of the mobility of the roller bodies within the corresponding recesses until the stop positions are reached.

Embodiments of the invention provide a device, system, and method for limiting the mobility of a rotary joint, preferably for a holding device for applications in human or veterinary medicine. The device comprises two joint parts that can be rotated and pivoted relative to one another about three axes, and at least one first roller body for limiting the relative mobility of the joint parts; wherein both joint parts each have at least one first recess for guiding the at least one first roller body between the joint parts and the respective stops of the recesses in order to move the joint parts relative to one another in an angle range limited by the stops.

The features shown in the description and the drawings can be used according to the invention individually or in groups in any combination without departing from the scope of the present disclosure.

While specific embodiments of the invention have been shown and described in detail to illustrate the application of the principles of the invention, it will be understood that the invention may be embodied otherwise without departing from such principles.

### LIST OF REFERENCE CHARACTERS

100 First joint unit with spherical-segment-shaped head part and joint neck
110 First joint part configured as a spherical-segment-shaped head part
129 Exterior surface
121 Recess formed as a guide groove
123 Angle range limited by stops 125, 126
124 Spherical equator running transverse to the outgoing axis a
125, 126 Stop
127 Curved cross-section; curvature
130 Joint neck
132 Buttons; actuating elements
133 Handle
135 Coupling device
200 Second joint unit with second joint part and connecting element
220 Second joint part
221 Recess in second joint part 220
222 Further recess in second joint part 220
225 Circumferential stop
230 Connecting element
241, 242 Opening(s)
244 Outer edge of the joint shell
229 Central opening
300 Joint
301 Holding segment
310 Arrow, the axial movement of the thrust element 320 along the longitudinal axis b
311 Arrow indicating clockwise rotation about axis a
313 Arrow indicating counter-clockwise rotation about axis a
320 Thrust element
321 Roller body
500 Holding system
520 Supply line
600 Method
601 First method step
602 Second method step
603 Third method step
700 Method
701 Method step
702 Further method step for assembly
703 Optional method step
a Longitudinal axis and axis of symmetry of the joint neck 130
b Axis of the connecting element and holding arm
c Transverse axis to the holding arm axis a
m Axis through centers of the circular recesses 221, 222
r Radius of the spherical first joint part 120
t Dividing line between upper and lower parts of the second joint part
X x-axis
D1 Outer diameter circular recess 121
D2 Outer diameter circular recess 221
L1 Running length of recess 121 along the curved longitudinal center line
L2 Running length along the direction of the inner diameter of the recess 221
M1 Sphere center of the first joint part 120p

1. A device for limiting the mobility of a rotary joint, the device comprising:
two joint parts which can be rotated and pivoted relative to one another about three axes; and
at least one first roller body for limiting the relative mobility of the joint parts; wherein both joint parts each have at least one first recess for guiding the at least one first roller body between the joint parts and corresponding stops of the at least one first recesses in order to move the joint parts relative to one another in an angle range limited by the stops.

2. A device according to claim 1, wherein the angle ranges of the corresponding recesses are summed.

3. A device according to claim 1, further comprising at least one second roller body, wherein both joint parts each have a second recess for guiding the corresponding second roller body.

4. A device according to claim 3, wherein the first joint part is configured to be locked by frictional engagement on an outer surface thereof.

5. A device according to claim 1, wherein the first joint part is configured as a spherical-segment-shaped head part, and the at least one first recess is configured as a longitudinal outer groove with the corresponding stops of the at least one first recesses comprises two stops along a spherical equator and comprises an angle of less than 70°, wherein the remaining protruding outer surface of the first joint part is available for engagement with the inner surface of the second joint part (220).

6. A device according to claim 1, wherein the at least one corresponding recess of the second joint part is configured as a circular inner running surface with a circumferential stop edge.

7. A device according to claim 1, wherein the roller body comprises a spherical roller body and wherein the corresponding recesses are in total deeper than an outer diameter of the corresponding spherical roller body.

8. A device according to claim 1, wherein the first joint part is a spherical-segment-shaped head part with a joint neck; and the second joint part is a joint shell which is configured in two parts for mounting the rotary joint in order to be able to accommodate the head part, wherein the joint shell engages over a spherical equator of the spherical-segment-shaped head part in a non-angled position of the joint in the mounted state.

9. A device according to claim 8, wherein the joint shell has at least one opening on a joint shell outer edge for receiving the joint neck (130) of the first joint part in order to be able to angle the axis of the joint neck up to 90°.

10. A device according to claim 1, wherein the second joint part can be connected via a connecting element to a holding segment in which an axially displaceable thrust element is arranged; and wherein the second joint part has a central opening in order to selectively lock or release the first joint part by means of a displacement of the thrust element (320).

11. A system comprising:
a rotary joint comprising a device for limiting mobility of the rotary joint, the device comprising: two joint parts configured to be rotated and pivoted relative to one another about three axes; and at least one first roller body for limiting the relative mobility of the joint parts, wherein each of the joint parts comprise a first recess for guiding the at least one first roller body between the joint parts and corresponding stops of the recesses in order to move the joint parts relative to one another in an angle range limited by the stops;
a holding device comprising at least one distal holding segment or a distal handle and a proximal holding segment for a medical device, each of which can be coupled to the rotary joint; and
a supply line for the medical device, which is guided from the first joint part to the second joint part by means of fixing devices, wherein a limitation of the mobility of the first joint part relative to the second joint part prevents damage to the supply line due to wrapping and/or tensile loads.

12. A system according to claim 11, wherein the rotary joint is a ball joint, and the joint shell is connected to the proximal holding segment; and the proximal holding segment comprises a thrust element that is axially displaceable by means of an actuating element in order to selectively lock or release the head part of the first joint part in a frictionally engaged manner.

13. A method for limiting the mobility of a rotary joint, the method comprising the following steps:
providing a two-part rotary joint with at least one recess in each joint part for at least one roller body;
guiding the at least one roller body between the joint parts in the corresponding recesses of the two joint parts; and
limiting movement of the joint parts relative to one another in a limited angle range due to the mobility of the at least one roller body within the corresponding recesses until the respective stops are reached.

14. A method according to claim 13, further comprising the following method steps:
connecting the second joint part via a connecting element to a holding segment in which an axially displaceable thrust element is arranged and configured for locking or releasing the first joint part,
wherein, for locking by means of frictional engagement, an axial displacement of the thrust element in the holding segment takes place through a central opening in the direction of the outer surface of the first joint part; and
wherein, for releasing, an axial displacement of the thrust element away from the outer surface of the first joint part takes place.

15. A method according to claim 14, further comprising the following method steps:
fixing a supply line to the first joint part and to the second joint part and/or a further holding segment by means of fixing devices;
wherein a limitation of the mobility of the first joint part relative to the second joint part prevents damage to the supply line due to wrapping and/or tensile loads.

16. A method according to claim 13, wherein the following method steps are carried out before the provision of the two-part rotary joint, which is configured as a ball joint and comprises a spherical-segment-shaped head part as the first joint part and a joint shell, which can be separated for assembly, as the second joint part:
inserting the first joint part with the at least one roller body into a lower part of the joint shell, wherein the joint neck of the spherical-segment-shaped joint part is guided out of the joint shell; and
enclosing the spherical-segment-shaped joint part with an upper part of the joint shell.

17. A method according to claim 13, further comprising the following method steps:
providing an opening or two openings in the outer edge of the joint shell for receiving the joint neck, and angling the axis of the joint neck of the first joint part up to 90°.

18. A method according to claim 14, wherein the following method steps are carried out before the provision of the two-part rotary joint, which is configured as a ball joint and comprises a spherical-segment-shaped head part as the first joint part and a joint shell, which can be separated for assembly, as the second joint part:
inserting the first joint part with the at least one roller body into a lower part of the joint shell, wherein the joint neck of the spherical-segment-shaped joint part is guided out of the joint shell; and
enclosing the spherical-segment-shaped joint part with an upper part of the joint shell.

19. A method according to claim 14, further comprising the following method steps:
providing an opening or two openings in the outer edge of the joint shell for receiving the joint neck, and angling the axis of the joint neck of the first joint part up to 90°.

20. A device according to claim 3, wherein the first and the second recesses are arranged opposite one another on the corresponding joint part.
